(19) United States
(12) Patent Application Publication
(10) Pub. No.: US 2023/0316346 A1
(43) Pub. Date: Oct. 5, 2023

(54) Novel Rating and Review System For Restroom Facilities

(71) Applicant: Michael Gamble, Westlake Village, CA (US)

(72) Inventor: Michael Gamble, Westlake Village, CA (US)

(21) Appl. No.: 17/712,062

(22) Filed: Apr. 1, 2022

(51) Int. Cl. G06Q 30/02

(52) U.S. Cl. CPC G06Q 30/0282

(57) ABSTRACT

The present invention generally relates to a rating and review system for public restroom facilities. The present invention describes a customer review platform (CRP) software application that receives a rating score of a venue's restroom cleanliness from subscriber patrons on a customer review platform within a network. Next, an overall rating score of the venue's restroom cleanliness is updated in response to receiving the rating score. The CRP software application can further dispatch services to the venue when a threshold number of ratings associated with the venue's restroom cleanliness is received within a first pre-defined time period.

### FIELD OF DISCLOSURE

The present invention generally relates to a rating and review system for public restroom facilities.

### BACKGROUND

In some states, restaurants, coffee shops, and other public venues have a duty to provide clean restrooms for its customers and guests in accordance with the law. For instance, in California, sports and entertainment arenas, community halls, convention centers, and other venues where the public congregates must have adequate restrooms to meet the needs of the public during peak hours. However, many public restrooms fail to meet the expected cleanliness standards of the public and are not regularly subjected to public review.

There are several research and review sites and applications for goods and services that are sold in the marketplace. For example, Yelp.com is a crowd-sourced business review and social networking site which has pages devoted to individual locations, such as restaurants or schools, where users can submit reviews of their products or services using a star rating scale. In addition to submitting reviews, Yelp users can react to reviews, plan events, and discuss their personal lives.

OpenTable is another online restaurant reservation service that allows users to search for restaurants and reservations based on dates, times, cuisine, and other parameters. Users who have registered can receive OpenTable reward points after dining and these points can be redeemed for discounts at member restaurants. The OpenTable service provides restaurant owners with comprehensive reservation management. Subscribing restaurants can use an Electronic Reservation Book (ERB) system to replace existing paper reservation systems which is an integrated software and hardware solution that computerizes restaurant host-stand operations. OpenTable's ERB handles reservation management, table management, guest recognition, and email marketing.

Although there are several applications for consumers to review and rate food preparation and dining services, a need exists for a rating and review system that is directed to public restroom facilities. The present invention meets this need.

### BRIEF OVERVIEW

This brief overview is provided to introduce a selection of concepts in a simplified form that is further described below in the Detailed Description. This brief overview is not intended to identify key features or essential features of the claimed subject matter. Nor is this brief overview intended to be used to limit the claimed subject matter's scope.

The present invention generally relates to a rating and review system for public restroom facilities. The present invention describes a customer review platform (CRP) software application that receives a rating score of a venue's restroom cleanliness from subscriber patrons on a customer review platform within a network. Next, an overall rating score of the venue's restroom cleanliness is updated in response to receiving the rating score. The CRP software application can further dispatch services to the venue when a threshold number of ratings associated with the venue's restroom cleanliness is received within a first pre-defined time period.

Both the foregoing brief overview and the following detailed description provide examples and are explanatory only. Accordingly, the foregoing brief overview and the following detailed description should not be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present invention. This text is included for illustrative, non-limiting, explanatory purposes of certain embodiments detailed in the present invention. In the drawings:

FIG. 1 illustrates a prior art depiction of a public restroom;

FIG. 2 illustrates an example computer network system which facilitates a platform for rating and reviewing a venue's restroom cleanliness according to one or more examples of the present invention;

FIGS. 3-9 illustrate various computing systems according to one or more embodiments of the present invention;

FIG. 10 illustrate an internet of things (IOT) system which can be employed within a restroom environment according to one or more embodiments of the present invention; and

FIG. 11 is a computing system according to one or more embodiments of the present invention.

### DETAILED DESCRIPTION

As a preliminary matter, it will readily be understood by one having ordinary skill in the relevant art that the present invention has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is part of the best mode contemplated for carrying out the embodiments of the present invention. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present invention.

Accordingly, while embodiments are described herein in detail in relation to one or more embodiments, it is to be understood that this disclosure is illustrative and exemplary of the present invention and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various sequences and orders while still falling within the scope of the present invention. Accordingly, it is intended that the scope of patent protection is to be defined by the issued claim(s) rather than the description set forth herein.

Additionally, it is worth noting that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as configured to: perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. § 112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” pre-defined distance does not necessarily imply that this pre-defined distance is the first pre-defined distance in a sequence; instead, the term “first” is used to differentiate this pre-defined distance from another pre-defined distance (e.g., a “second” pre-defined distance).

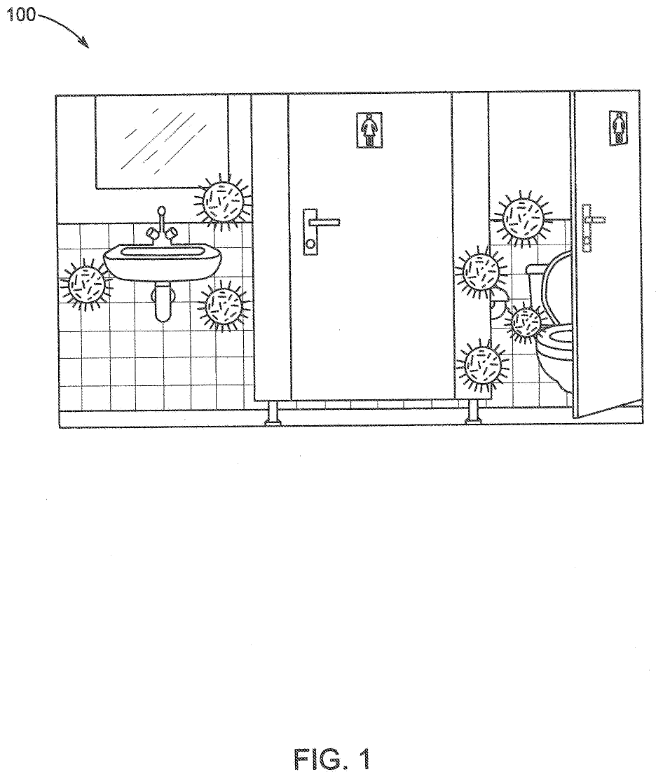

FIG. 1 illustrates a prior art depiction of a public restroom 100. Herein, a public restroom 100 is a room or suite of rooms in a public space providing toilets and lavatories. For example, a public restroom 100 may be a public bathroom. However, given their warm and humid environment, public restrooms provide ideal environments for microorganisms to survive and reproduce. Many pathogens, including Shigella spp., Escherichia coli, Pseudomonas aeruginosa, Acinetobacter baumanii, Staphylococcus aureus, and norovirus can survive on restroom surfaces for weeks or months.

Furthermore, a study published in “Applied and Environmental Microbiology” assessed the microbes present in public restrooms. Genetic traces of more than 77,000 distinct types of bacteria and viruses were discovered in these spaces. In other studies, it was found that within an hour of regular use, there may be greater than 500,000 bacterial cells per square inch on restroom surfaces.

Contaminated areas are not confined to toilet facilities and their immediate environment within restrooms but have been found in hand-drying facilities. For instance, aerosol generated from warm-air hand dryers can transmit pathogenic bacteria onto the hands and bodies of users.

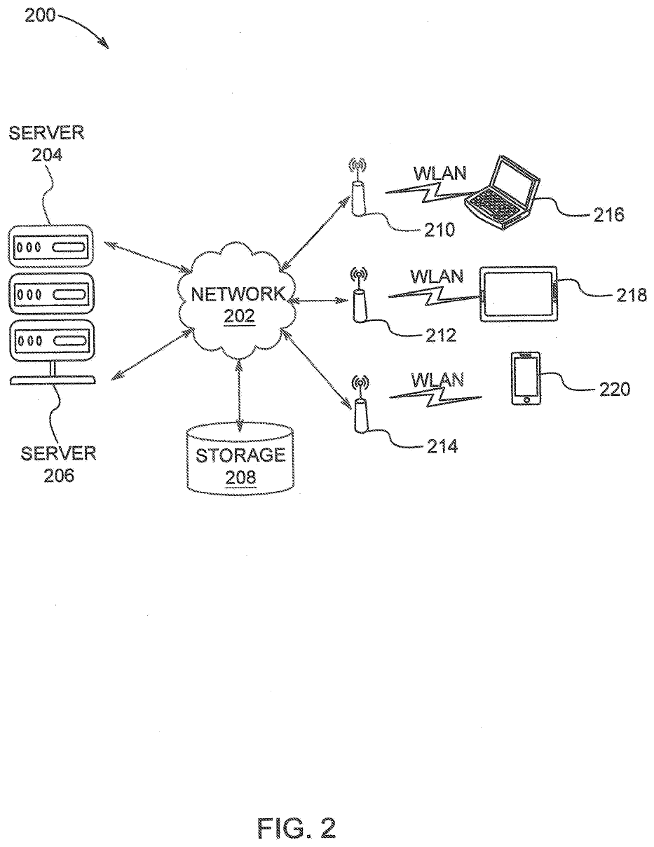

FIG. 2 illustrates an example computer network system that facilitates a platform for rating and reviewing a venue's restroom cleanliness according to one or more examples of the present invention. The customer review platform is implemented by a software application or system. In some embodiments, the present invention includes as client-side software application accessible by subscriber patrons and a server-side software application pre-programmed to respond to instructions initiated on the client-side software application. As such, the customer review platform may include both the client-side software application and server-side software application. In one implementation, the client patron-side software application may be accessible by both patrons and proprietors to make requests and carryout instructions on the customer review platform. In other embodiments, the customer review platform includes a client-patron side software application on the client-proprietor side software application, and a server-side software application.

The customer review platform may be hosted on one or more servers 204, 206 with system data stored thereon or in peripheral databases 208.

Computer network system 200 is a network of data processing systems, such as, for example, computers and other devices, in which the illustrative embodiments may be implemented. One or more client devices employed within computer network system 200 may include a display screen, a plurality of microprocessors, and memory.

Computer network system 200 may include one or more networks which provide communication links between the various computers and other devices connected together within the computer network system 200. In some implementations, network 202 includes connections, such as wire(s), wireless communication links, fiber optic cables, etcetera.

In the example depicted in computer network system 200, servers 204, 206, and storage unit 208 are connected to network 202. The storage unit 208 may be capable of storing data in a structured or unstructured format. Additionally, storage unit 208 may represent a plurality of storage units coupled to network 202. In some implementations of the present invention, storage unit 208 may, for example, include any database within an enterprise that stores and manages reusable software assets and any other data related to these reusable software assets. Access Points 210, 212, and 214 may function as a network device that allows client devices to connect to a wired network. However, the present invention is not limited thereto. In some implementations, an access point may connect to a router as a standalone device but may also be an integral component of the router itself in some implementations.

In addition, access points 210, 212, 214 may provide wireless access to client devices 216, 218, 220. Client devices 216, 218, 220 may include personal computers, network computers, laptop computers, hand-held computers, personal digital assistants (PDAs), or smart cellular telephones (e.g., smartphones). It should also be understood by those having ordinary skill in the art that the client devices can be used to access, retrieve, and submit information to the customer review platform.

In the embodiment shown, client device 216 is a laptop computer, client device 218 is a tablet, and client device 220 is a smartphone device. However, one having ordinary skill in the art should appreciate that the present invention is not limited to the specific network of client devices shown in FIG. 2.

In the implementation shown, access points 210, 212, and 214 are clients to server 204 and/or server 206. In addition, server 204 and/or server 206 may provide data, such as, for example, boot files, operating system images, and applications to access points 210, 212, and 214. Computer network system 200 may include additional servers, clients, and other devices not shown to implement processes of illustrative implementations.

In addition, computer network system 200 includes one or more servers, such as servers 204, 206, which contain rating and review restroom cleanliness data for a plurality of venues. The servers which contain this data may filter this data in various manners in response to requests for venue or secondary service recommendations. For example, one or more servers may send to a client device associated with a subscriber patron the names of venues that are within a pre-defined distance from the subscriber patron which meets a rating or review score criteria after filtering through voluminous rating and review data on the server(s).

Computer network system 200 may be implemented as a number of different types of networks, such as, for example, an intranet, a local area network (LAN), a wide area network (WAN), or the Internet. It should be noted that FIG. 2 is only intended as an example and not as an architectural limitation for the different illustrative implementations. For example, illustrative implementations may be implemented within a single data processing system or within a computer network system.

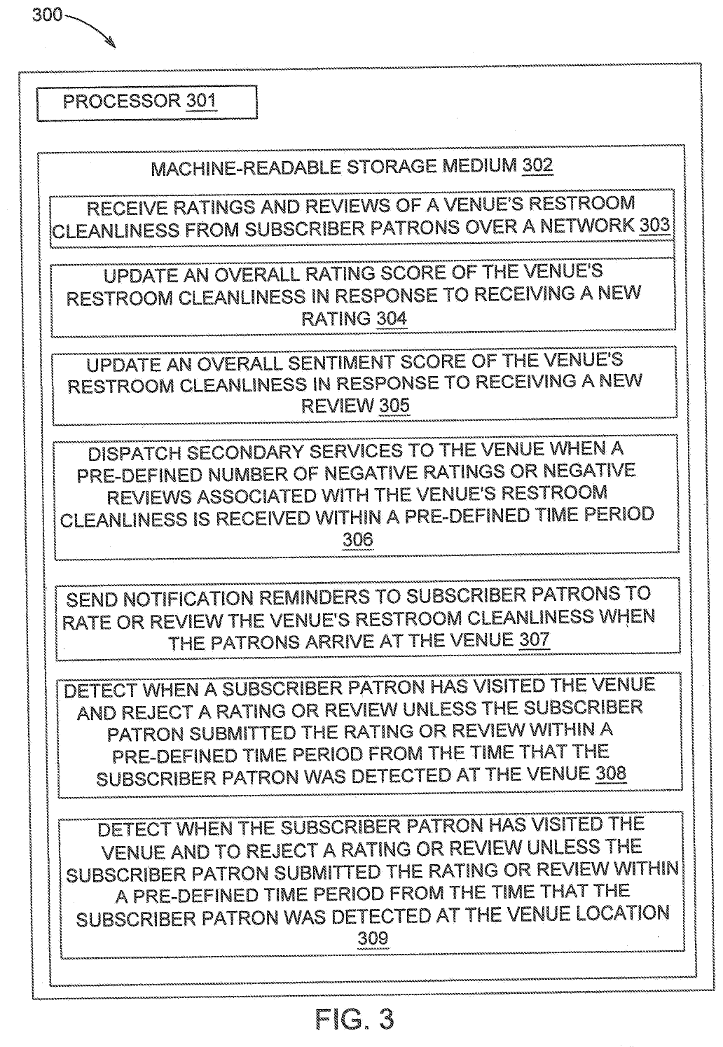

FIG. 3 illustrates computing systems according to one or more embodiments of the present invention. The computing system 300 includes the non-transitory computer readable medium 302 that includes computer executable instructions 303-308 stored thereon that, when executed by one or more processing units 301 (one processor shown), causes the one or more processing units 301 to serve as a customer review platform consistent with the present invention.

Computer readable medium 302 includes computer executable instructions 303 to receive ratings and reviews of a venue's restroom cleanliness from subscriber patrons over a network. In some implementations, the ratings and reviews constitute feedback from subscriber patrons (e.g., consumers) regarding a venue's restroom cleanliness. In some embodiments, a review may include a written assessment of the venue's restroom cleanliness or lack thereof. For example, a review of a restroom facility may include feedback regarding the presence of soap, tissue, hand towels, sanitizer, etcetera.

Moreover, a rating may be based on a rating score (e.g., a score from 1-10). If a rating score has already been submitted for a particular venue's restroom, computer executable instructions 304 can update an overall rating score of the venue's restroom cleanliness in response to receiving a new rating. Furthermore, if reviews have already been submitted for a particular venue's restroom cleanliness, computer executable instructions 305 update an overall sentiment score of the venue's restroom cleanliness in response to receiving a new review.

Furthermore, computer readable medium 302 includes computer executable instructions 306 to dispatch secondary services to the venue when a pre-defined number of negative ratings or negative reviews associated with the venue's restroom cleanliness is received within a pre-defined time period.

For example, if at least three consecutive negative ratings or reviews are received within an hour of time, a janitorial service may be dispatched to the venue to perform cleaning services in the venue's restroom facility. The time period may be on the order of minutes or hours in some embodiments. It should be understood by those having ordinary skills in the art that the secondary services dispatched to the venue are not limited to janitorial services. The secondary services may include restroom attendant services, plumbing services, etcetera.

The secondary services may include restroom attendant services. Because public restrooms at busy venues generally become messy due to venue traffic, venues that want to make a good impression on patrons or desire to provide a higher level of customer service can employ restroom attendants to furnish hand towels or other toiletries to customers. In upscale venues, restroom attendants may even provide personal care items.

Additionally, computer readable medium 302 includes computer executable instructions 307 to send notifications regarding other ratings and reviews submitted by patrons of the venue regarding its restroom's cleanliness. For example, when a subscriber patron is presently dining in a restaurant and another patron submits a rating or review of the venue's restroom cleanliness via the customer ratings platform, the subscriber patron may be sent a peer notification of the rating and review that was submitted. These peer notifications may serve as reminders for the subscriber patrons to use the customer review platform and submit a rating or review of the venue's restroom.

Computer readable medium 302 also includes computer executable instructions 308 to detect when the subscriber patron has visited the venue and to reject a rating or review unless the subscriber patron submitted the rating or review within a pre-defined time period from the time that the subscriber patron was detected at the venue.

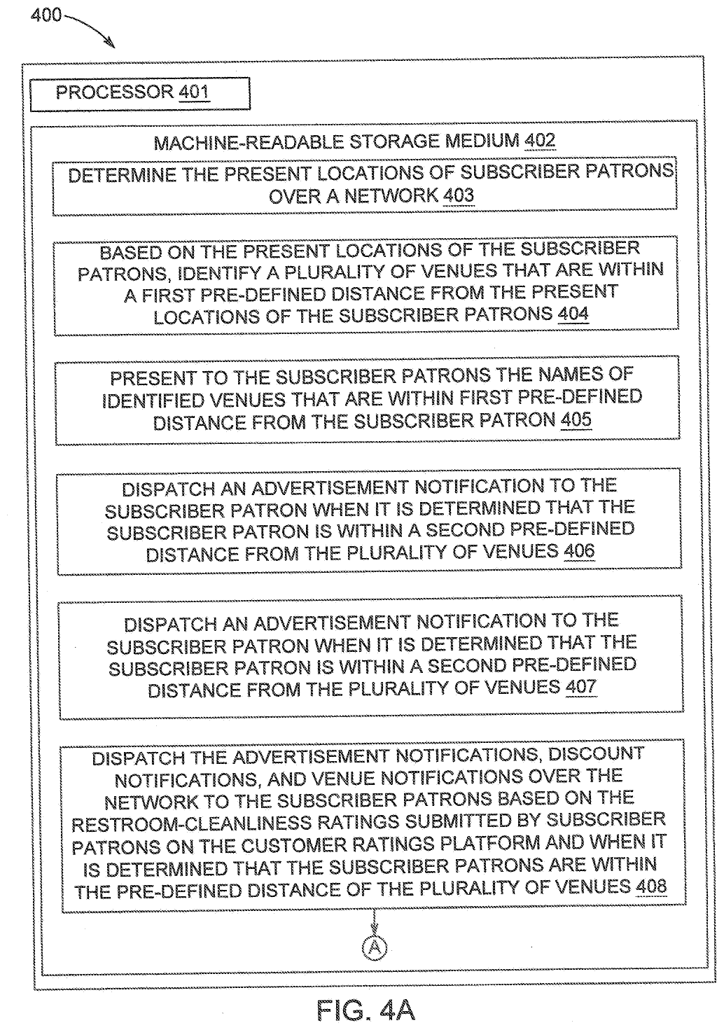

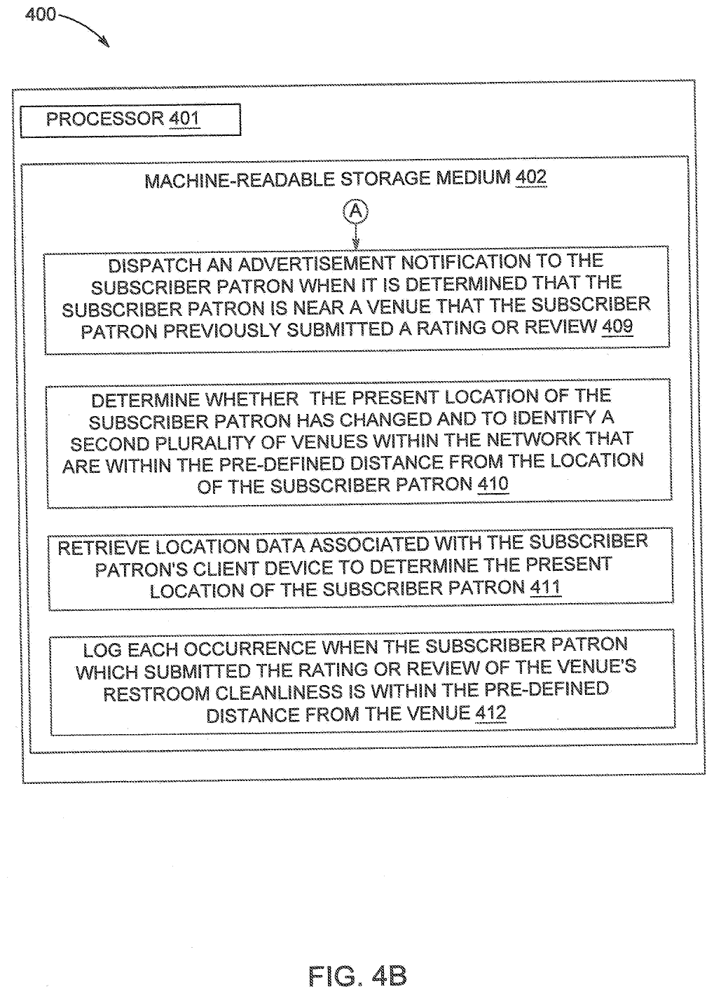

FIGS. 4A-4B illustrate computing systems according to one or more embodiments of the present invention. The computing system 400 includes a non-transitory computer readable medium 402 that includes computer executable instructions 403-411 stored thereon that, when executed by one or more processing units 401 (one processor shown), causes the one or more processing units 401 to serve as a customer review platform consistent with the present invention.

Computer readable medium 402 includes computer executable instructions 403 to determine the present location of subscriber patrons over a network. Based on the present locations of the subscriber patrons, identify a plurality of venues that are within a first pre-defined distance from the present locations of the subscriber patrons, according to computer executable instructions 404. In some embodiments, the pre-defined distance is a radius that represents a geofence around the venue. Furthermore, in one embodiment, each venue is associated with a restroom cleanliness rating calculated from the submissions of subscriber patrons made over the network.

Further, computer readable medium 402 includes computer executable instructions 405 to present to the subscriber patrons the names of identified venues that are within a first pre-defined distance from the subscriber patrons. Furthermore, computer readable medium 402 includes computer executable instructions 406 to dispatch an advertisement notification, a discount notification, or venue recommendation to the subscriber patron when it is determined that the subscriber patron is within a second pre-defined distance from the plurality of venues.

Computer readable medium 402 includes computer executable instructions 407 to dispatch the advertisement notification, a discount notification, or a venue recommendation over the network based on the restroom-cleanliness ratings submitted by subscriber patrons on the customer ratings platform and when it is determined that the subscriber patrons are within the pre-defined distance of the plurality of venues. In some embodiments, the advertisement notifications, discount notifications, or venue recommendations are in-app messages created and dispatched on a client-proprietor side of a customer review platform and received by subscriber patrons on a client-patron side of the customer review platform.

In addition, computer readable medium 402 includes computer executable instructions 408 to dispatch an advertisement notification to the subscriber patron when it is determined that the subscriber patron is near a venue that the subscriber patron previously submitted a rating or review.

Additionally, computer readable medium 402 includes computer executable instructions 409 to determine whether the present location of the subscriber patron has changed and to identify a second plurality of venues within the network that is within the pre-defined distance from the location of the subscriber patron.

Computer readable medium 402 also includes computer executable instructions 410 to retrieve location data (e.g., GPS data) associated with the subscriber patron's client device to determine the present location of the subscriber patron.

Further, computer readable medium 402 includes computer executable instructions 411 to log each occurrence when the subscriber patron which submitted the rating or review of the venue's restroom cleanliness is within the pre-defined distance from the venue.

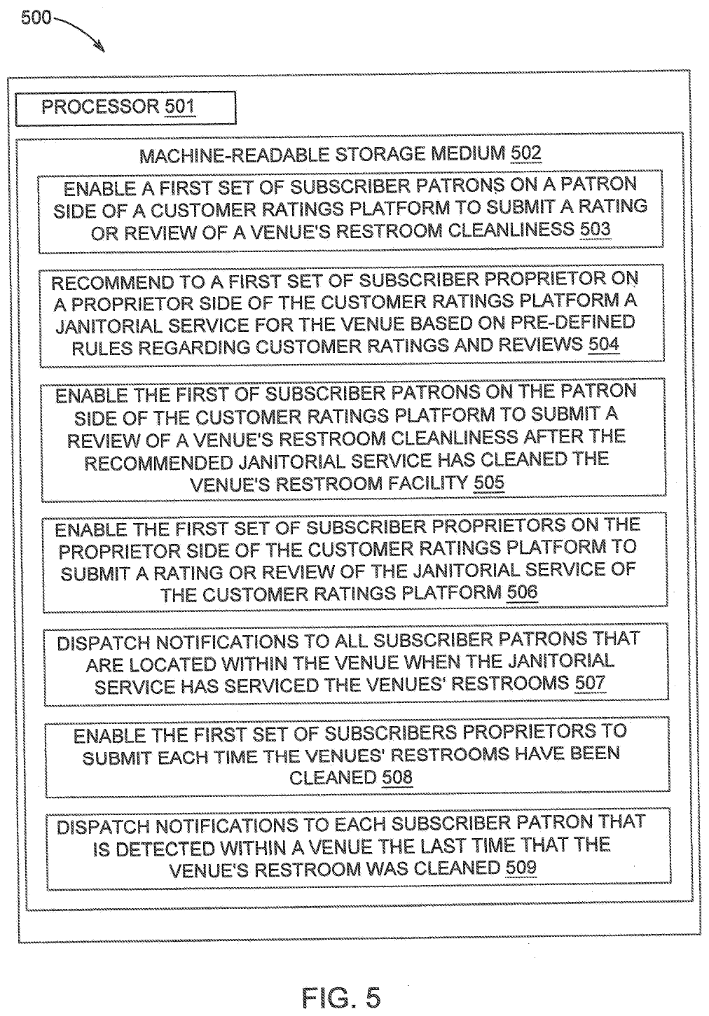

FIG. 5 illustrates computing systems according to one or more embodiments of the present invention. The computing system 500 includes a non-transitory computer readable medium 502 that includes computer executable instructions 503-508 stored thereon that, when executed by one or more processing units 501 (one processor shown), causes the one or more processing units 501 to serve as a customer review platform consistent with the present invention.

Computer readable medium 502 includes computer executable instructions 503 to enable a first set of subscriber patrons on a client-patron side of a customer ratings platform to submit a rating or review of a venue's restroom cleanliness. In some embodiments, subscribers of the customer ratings platform that are patrons or guests (e.g., subscriber patrons) of the venues are limited to access to the client-patron side of the customer ratings platform such that they can submit ratings or reviews regarding a venue's restroom cleanliness.

In some embodiments, a client-patron side of the customer ratings platform enables subscribers patrons to submit ratings or reviews regarding a venue's restroom cleanliness. In addition, the client-patron side of the customer ratings platform allows subscriber patrons to receive notifications (e.g., advertisements notifications or venue recommendations). Furthermore, subscribers can view ratings and reviews submitted by other users on the customer ratings platform. Users can also create their own account on the customer ratings platform or submit ratings and reviews as a guest (e.g., via a web interface).

In some embodiments, a proprietor side of the customer ratings platform enables subscriber proprietors to submit and access ratings and reviews of secondary services. The proprietor side of the customer ratings platform can also enable the frequency and coverage area for advertisements by the subscriber proprietors. Furthermore, the proprietor side enables proprietors to set up reminder notifications for subscriber patrons to submit ratings or reviews on the customer rating platform.

Additionally, computer readable medium 502 includes computer executable instructions 504 to recommend to a first set of subscriber proprietors on a proprietor side of the customer ratings platform a janitorial service for the venue based on pre-defined rules regarding customer ratings and reviews.

In addition, computer readable medium 502 includes computer executable instructions 505 to enable the first set of subscriber patrons on the client-patron side of the customer ratings platform to submit a review of a venue's restroom cleanliness after the recommended janitorial service has cleaned the venue's restroom facility. Alternatively, computer executable instructions 506 enable the first set of subscriber proprietors on the proprietor side of the customer review platform to submit a rating or review of the janitorial service on the customer ratings platform.

In some embodiments, subscribers of the customer ratings platform that are business owners, managers, or other employees (e.g., subscriber proprietors) of the venue that is being rated or reviewed can access the ratings and reviews of the secondary services (e.g., janitorial service).

Additionally, computer readable medium 502 includes computer executable instructions 507 to dispatch notifications to all subscriber proprietors that are located within the venue when the janitorial service has serviced the venues' restrooms. In some embodiments, the subscriber proprietor can set a rating or review threshold on the customer ratings platform which can trigger a notification in response to an unsatisfactory rating or review.

Furthermore, computer readable medium 502 includes computer executable instructions 508 to enable the first set of subscriber proprietors to submit each time the venues' restrooms have been cleaned.

Next, computer readable medium 502 includes computer executable instructions 509 to dispatch notifications to each subscriber patron that is detected within a venue the last time that the venue's restroom was cleaned.

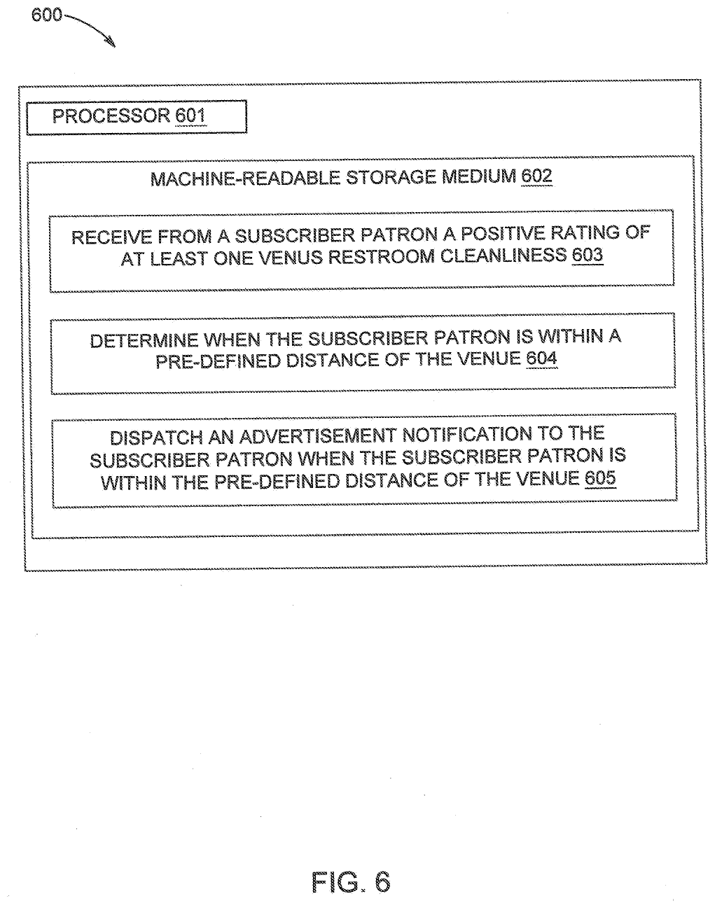

FIG. 6 illustrates computing systems according to one or more embodiments of the present invention. The computing system 600 includes a non-transitory computer readable medium 602 that includes computer executable instructions 603-605 stored thereon that, when executed by one or more processing units 601 (one processor shown), causes the one or more processing units 601 to serve as a customer review platform consistent with the present invention. Computer readable medium 602 includes computer executable instructions 603 to receive from a subscriber patron a positive rating of at least one venue's restroom cleanliness.

Further, computer readable medium 602 includes computer executable instructions 604 to determine when the subscriber patron is within a pre-defined distance from the venue. In one embodiment, GPS tracking capability of the subscriber patron's smartphone device may use the Global Navigation Satellite System network to give location information and track movements. GPS devices may receive satellite and microwave signals and use calculations to determine a location and to track speed and movement. The customer ratings platform described herein may employ GPS tracking capability to track the subscriber patron's client device to determine when subscriber patrons are within a pre-defined distance(s) from the venue(s) of interest.

Additionally, computer readable medium 602 includes computer executable instructions 605 to dispatch an advertisement notification to the subscriber patron when the subscriber patron is within the pre-defined distance from the venue. For example, when a subscriber patron is near a venue that they previously submitted a rating or review of the venue's restroom cleanliness, the customer ratings platform can be configured to issue an advertisement notification. In some embodiments, the pre-defined distance is configurable such that it may be set or reset by subscriber patrons or subscriber proprietors.

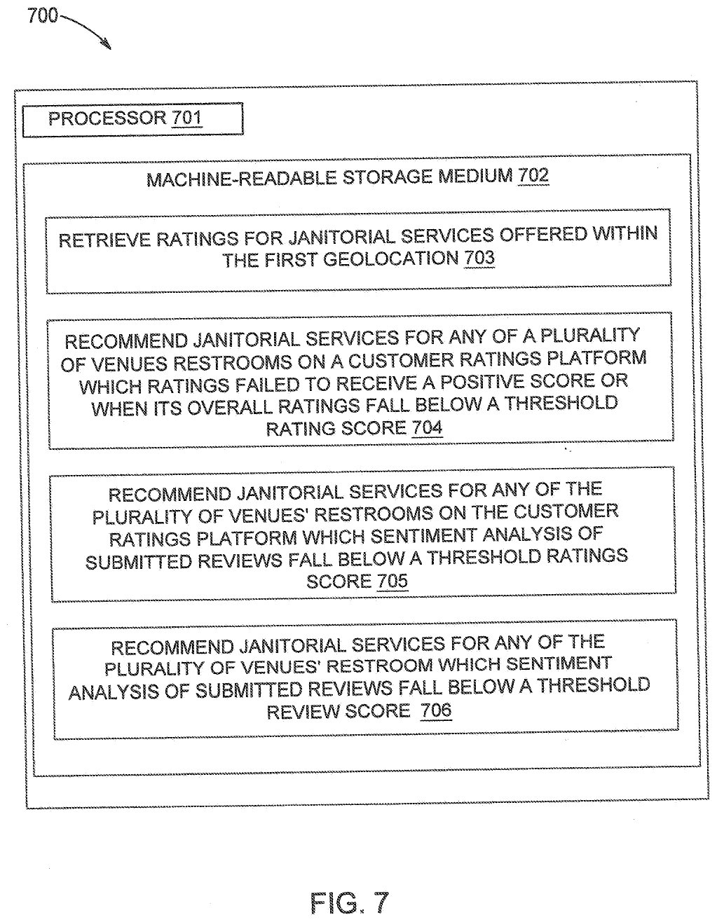

FIG. 7 illustrates computing systems according to one or more embodiments of the present invention. The computing system 700 includes a non-transitory computer readable medium 702 that includes computer executable instructions 703-706 stored thereon that, when executed by one or more processing units 701 (one processor shown), causes the one or more processing units 701 to serve as a customer ratings platform consistent with the present invention.

Computer readable medium 702 includes computer executable instructions 703 to retrieve ratings or reviews for janitorial services offered within the first geolocation. In addition, computer readable medium 702 includes computer executable instructions 704 to recommend janitorial services for any of a plurality of venues' restrooms on a customer ratings platform which ratings failed to receive a positive score or when its overall ratings fall below a threshold ratings score.

Additionally, or alternatively, computer readable medium 702 includes computer executable instructions 705 to recommend janitorial services for any of the plurality of venue's restrooms on the customer ratings platform which sentiment analysis of submitted reviews fall below a threshold ratings score.

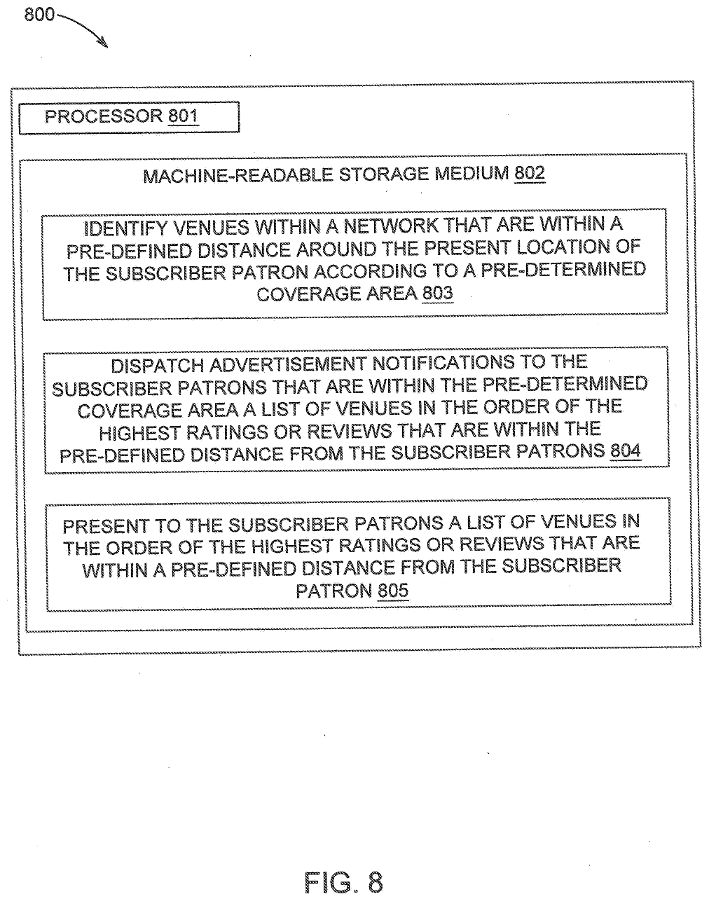

FIG. 8 illustrates computing systems according to one or more embodiments of the present invention. The computing system 800 includes a non-transitory computer readable medium 802 that includes computer executable instructions 803-805 stored thereon that, when executed by one or more processing units 801 (one processor shown), causes the one or more processing units 801 to serve as a customer review platform consistent with the present invention.

Computer readable medium 802 includes computer executable instructions 803 to identify venues within a network that are within a pre-defined distance around the present location of the subscriber patron according to a pre-defined coverage area.

Computer readable medium 802 includes computer executable instructions 804 to dispatch advertisement notifications to the subscriber patrons that are within the pre-defined coverage area a list of venues in the order of the highest ratings or reviews that are within the pre-defined distance from the subscriber patrons. The frequency and coverage area may be configurable parameters of the customer ratings platform.

The customer ratings platform may also be configurable to allow a subscriber proprietor to modify the frequency of advertisement notifications that are sent out to the venue's customers that have submitted a rating of the venue's restroom. For example, the subscriber proprietor may configure the customer review platform to send advertisement notifications to their customers manually or on a periodic frequency. In addition, a subscriber proprietor can configure the customer ratings platform to dispatch advertisement notifications once per day regardless of the number of times that a subscriber patron is within the pre-defined distance from the venue.

The subscriber proprietor can also configure the customer ratings platform to set the pre-defined distance from the venue that customers must be presently located in before advertisement notifications can be dispatched.

In some embodiments, the frequency of the advertisement notifications is configurable on both the client-patron side and the client-proprietor side of the customer ratings platform. For example, a subscriber patron can configure the customer ratings platform to receive advertisement notifications according to a pre-defined frequency (e.g., per hour/day). Subscriber patrons can also select which venues that they choose to receive advertisement notifications.

In addition, subscriber patrons can select the geographic areas where it desires to receive advertisement notifications. For example, if a subscriber patron resides or works near a shopping area, the subscriber patron may elect to decline from receiving advertisement notifications from venues in this area as frequent advertisement notifications may create a nuisance.

Additionally, computer readable medium 802 includes computer executable instructions 805 to present to the subscriber patrons a list of venues in the order of the highest ratings or reviews that are within a pre-defined distance from the subscriber patrons.

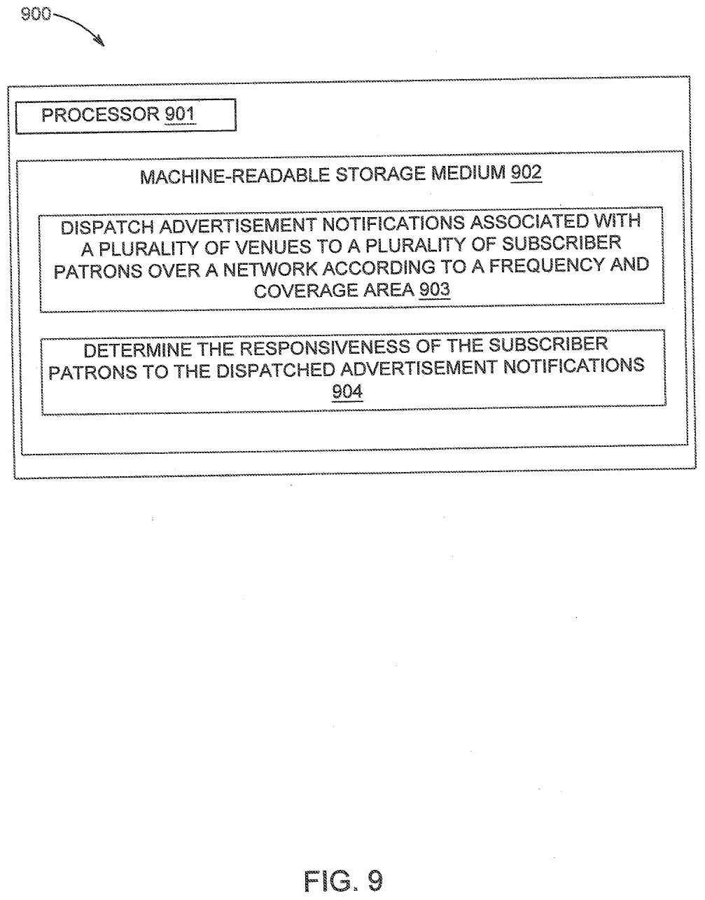

FIG. 9 illustrates computing systems according to one or more embodiments of the present invention. The computing system 900 includes a non-transitory computer readable medium 902 that includes computer executable instructions 903-905 stored thereon that, when executed by one or more processing units 901 (one processor shown), causes the one or more processing units 901 to customer review platform consistent with the present invention.

Computer readable medium 902 includes computer executable instructions 903 to dispatch advertisement notifications associated with a plurality of venues to a plurality of subscriber patrons over a network according to a pre-defined frequency and coverage area.

Computer readable medium 902 includes computer executable instructions 904 to determine the responsiveness of the subscriber patrons to the dispatched advertisement notifications. For example, after an advertisement notification is sent to a subscriber patron, the patron's client device may be tracked for a pre-defined time period to determine whether, and to what frequency, the subscriber patron visits a particular venue. These visits to the venues after the advertisement notifications are sent to the subscriber patrons may be referred to as conversions. Analytics associated with the conversions may be generated via a cloud service. Analytics may determine the likelihood of conversions according to venue type, advertisement time of day or week, subscriber patron demographics, a number of other advertisements received, etcetera.

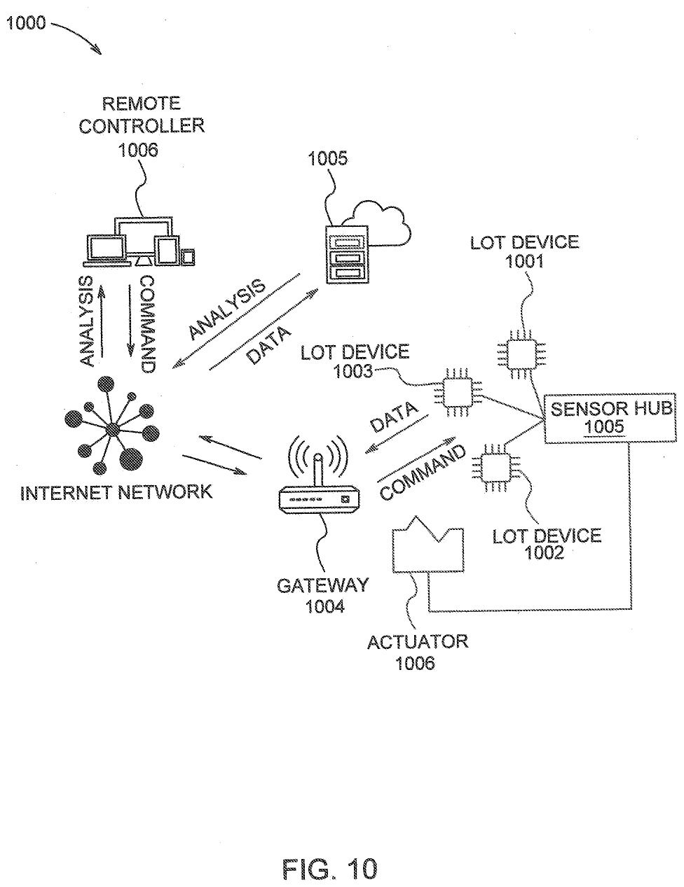

FIG. 10 illustrates an internet of things (IoT) system 1000 which can be employed within a restroom environment according to one or more embodiments of the present invention. Internet of Things (IoT) system 1000 includes interrelated computing devices, mechanical and digital machines, etcetera that are provided with unique identifiers with the ability to transfer data over a network without requiring human-to-human or human-to-computer interaction. IoT system 1000 may also include a network of devices, sensors, actuators, and cloud services that interconnect with one another to be able to decipher data and consequently perform an action.

Conventional IoT sensors 1001-1003 can measure light, motion, moisture, air quality, temperature, etcetera. In the present invention, sensors 1001-1003 can measure fecal matter, allergies, viruses, or other bacteria within an enclosed airspace of a restroom facility. IoT sensors 1001-1003 when paired with an internet connection, enables the collection of information from the environment which, in turn, helps make better decisions. IoT sensors 1001-1003 may capture relevant data for real-time or post-processing.

It should be appreciated by one having ordinary skill in the art that the present invention is not limited to a sensor that measures the aforementioned bacteria examples. As such, the IoT sensors 1001-1003 can measure various other bacteria so long as doing so is consistent with the present invention. The collected measurement data can be routed to external services (e.g., servers of a cloud system) to determine whether a secondary service should be dispatched to the venue.

In some implementations, the collected measurement data is sent for inspection by the health department or any other sanctioned authority. The collected measurement data may lead to a follow-up investigation of the venue by the relevant authority. Once the IoT sensors 1001-1003 have detected a change in the environment, an actuator 1006 can move or control some mechanism of the IoT system 1000 based on the trigger. Further, actuator 1006 may contain an electrically-operated switch that displays one or more colors to indicate the degree of fecal matter or other airborne matter within a restroom facility. For instance, the relay actuator 1006 may elicit the color red to indicate a particulate level that needs to be immediately addressed. As such, the read out of actuator 1006 or the collected measurements by the sensors 1001-1003 may be transmitted to cloud service for processing and may lead to the dispatch of secondary services to the venue's restroom facility.

Once the measurement data has been collected by the IoT sensors 1001-1003 or sensor hub 1005, the collected data is sent to the cloud system. IoT protocols are responsible for transferring data online. IoT standards and protocols facilitates the communication of physical objects with each other. The choice of a network depends on factors such as power consumption, speed of data transfer, range, bandwidth and overall efficiency. Some exemplary IoT wireless protocols and standards include Bluetooth, Wi-Fi, ZigBee, LoRaWAN, DDS, MQTT, cellular, etcetera.

In some embodiments, IoT sensor 1000 may also include a sensor hub 1005. Sensor hub 1005 may comprise a microprocessor unit, coprocessor, or DSP unit which integrates data from different sensors 1000-1003 and processes them.

Incoming raw data from the IoT sensors 1001-1003 may pass through gateways to reach the cloud system. Gateways 1004 translates network protocols ensuring seamless communication of all devices within the network. Moreover, gateway 1004 offers security by protecting the system from unauthorized access and malicious attacks and can function as a security layer as the data flowing through it may be protected by the latest encryption practices. Gateways 1004 can also preprocess data from the IoT sensors 1001-1003 before sending it to the cloud system.

Once the measurement data has been collected and sent to the cloud, measurement data is processed. Devices, protocols, gateway and storage can be combined for efficient real-time data analysis.

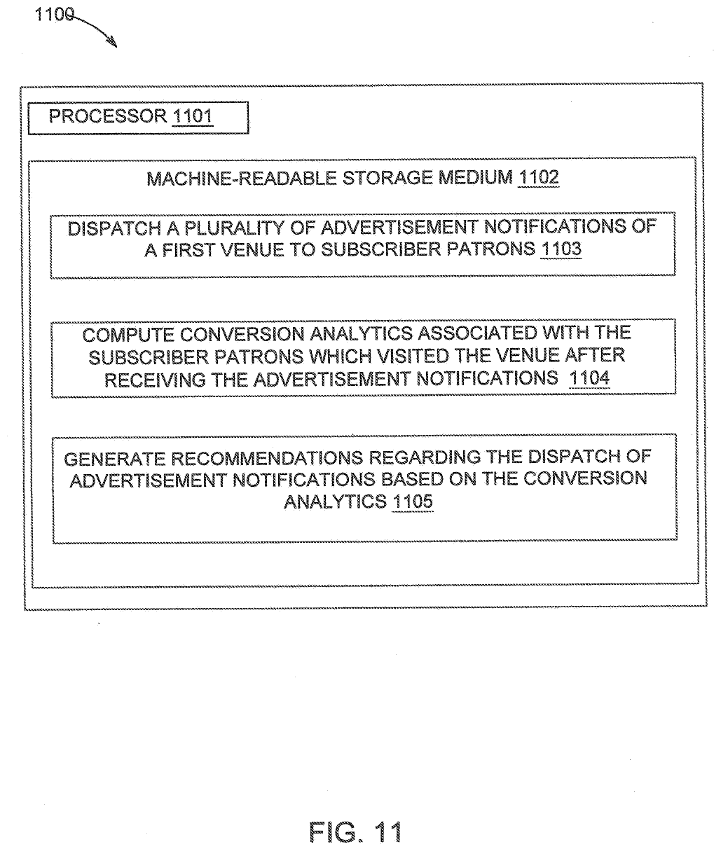

FIG. 11 is a computing system according to one or more embodiments of the present invention. The computing system 1100 includes a non-transitory computer readable medium 1102 that includes computer executable instructions 1103-1105 stored thereon that, when executed by one or more processing units 1101 (one processor shown), causes the one or more processing units 1101 to customer review platform consistent with the present invention.

Computer readable medium 1102 includes computer executable instructions 1103 to dispatch a plurality of advertisement notifications associated with a first venue to subscriber patrons. Computer readable medium 1102 includes computer executable instructions 1104 to compute conversion analytics associated with the subscriber patrons which visited the venue after receiving the advertisement notifications. In some embodiments, the subscriber patron's client devices are tracked once advertisement notifications are dispatched to the subscriber patrons.

For example, the GPS data associated with a subscriber patron's client device is tracked right after the advertisement notification is sent and received to determine the time that it takes for the subscriber patron to visit the venue associated with the advertisement notification after the notification is dispatched.

In yet another example, two or more advertisement notifications are sent to subscriber patrons in accordance with a pre-defined transmission schedule. The GPS data associated with the subscriber patrons' client devices are tracked to determine their responsiveness to a set of advertisement notifications. As such, the customer ratings platform can test various transmission schedules to determine the subscriber patrons' responsiveness to the sets of advertisement notifications.

In addition, the customer ratings platform can identify trends associated with the conversions. For example, demographic data, time of day that the advertisement notifications are sent, etcetera may reveal conversion trends and may inform how subscriber patrons construct future advertisement notifications. The present invention also provides for an automated advertisement notification process based upon the identified trends in the various transmission schedules. Accordingly, subscriber patrons can create a set of advertisement notifications to be sent according to a transmission schedule that is determined by the customer ratings platform. The transmission schedules generated by the customer ratings platform may be updated according to the trend data obtained from the sets of advertisement notification transmissions dispatched across the customer ratings platform and its analytics.

Computer readable medium 1102 includes computer executable instructions 1105 to generate recommendations regarding the dispatch of advertisement notifications based on conversion analytics. Accordingly, the customer ratings platform can generate recommendations of advertisement notifications' transmission schedules.

Furthermore, discount notifications may also be dispatched to the subscriber patrons as previously described. In some embodiments, a subscriber patron's client device that was sent discount notifications is tracked. In yet another example, a set of discount notifications are sent to subscriber patrons in accordance with a pre-defined transmission schedule. In one implementation, the GPS data associated with client devices of the subscriber patrons which were sent the discount notifications are tracked to determine the responsiveness of the subscriber patrons to the set of discount notifications. Accordingly, the customer ratings platform can test different pre-defined transmission schedules to determine the responsiveness of the subscriber patrons to the sets of discount notifications.

In addition, the customer ratings platform can identify trends associated with the conversions. For example, demographic data, sex data, time of day associated with the discount notifications, etc. may reveal conversion trends. This data may inform how subscriber patrons construct future discount notifications. The present invention also provides for an automated discount notification process based upon the identified trends in the various transmission schedules. Accordingly, subscriber patrons can create a set of discount notifications to be sent according to a transmission schedule that is determined by the customer ratings platform. The transmission schedules generated by the customer ratings platform may be frequently updated according to the trend data obtained from the several sets of discount notification transmission dispatched across the customer ratings platform.

Aspects of the Invention

Aspect 1

A computing device comprising a non-transitory machine-readable storage medium containing instructions that, when executed, causes a machine to:
receive a review of a venue's restroom cleanliness from subscriber patrons on a network;
update an overall rating score of the venue's restroom cleanliness in response to receiving the review; and
dispatch secondary services to the venue when a first number of reviews associated with the venue's restroom cleanliness is received within a first time period.

Aspect 2

A computing device comprising a non-transitory machine-readable storage medium containing instructions that, when executed, causes a machine to:
retrieve a present location of a subscriber patron, the subscriber patron being a member of a network;
based on the present location of the subscriber patron, identify a plurality of venues within the network that are within a first pre-defined distance from the present location of the subscriber patron,
wherein each of the plurality of venues is associated with a restroom cleanliness rating calculated from the submissions of subscriber patrons over the network; and present to the subscriber patron the identity of the plurality of venues within the first pre-defined distance according to the restroom cleanliness rating.

Aspect 3

A computing device comprising a non-transitory machine-readable storage medium containing instructions that, when executed, causes a machine to:
enable a first set of subscriber patrons on a client-patron side of a customer ratings platform to submit a review of a venue's restroom cleanliness; and
recommend on a proprietor side of the customer ratings platform a janitorial service for the venue based on pre-defined rules.

Aspect 4

A computing device comprising a non-transitory machine-readable storage medium containing instructions that, when executed, causes a machine to:
receive from a subscriber patron a positive rating of at least one venue's restroom cleanliness, wherein the subscriber patron is a member of a network;
determine when the subscriber patron is within a pre-defined distance of the at least one venue; and dispatch an advertisement notification to the subscriber patron when the subscriber patron is within the pre-defined distance of the at least one venue.

Aspect 5

A computing device comprising a non-transitory machine-readable storage medium containing instructions that, when executed, causes a machine to:
enable subscriber patrons over a network to rate a plurality of venues on the network which are located within a first geolocation based on restroom cleanliness;
retrieve ratings for janitorial services offered within the first geolocation; and
recommend at least one of the janitorial services to any of the plurality of venues which ratings failed to receive a positive score.

Aspect 6

A computing device comprising a non-transitory machine-readable storage medium containing instructions that, when executed, causes a machine to:
receive an indication from a subscriber patron to identify a venue for patronage, wherein the subscriber patron is member of a network;
based on a present location of the subscriber patron, identify venues within the network that are within a pre-defined area around the present location of the subscriber patron,
wherein a rating of restroom cleanliness is associated with each venue within the network;
identify each of the plurality of venues within the pre-defined area with the highest ratings within a pre-defined time frame; and
present to the subscriber patron a list of venues within the pre-defined area with the highest rating within a pre-defined time frame.

Aspect 7

A computing device comprising a non-transitory machine-readable storage medium containing instructions that, when executed, causes a machine to:
dispatch advertisement notifications associated with a plurality of venues to a plurality of subscriber patrons over a network according to a frequency and coverage area;
retrieve reviews associated with restroom cleanliness of the plurality of venues; and
increase the frequency and coverage area that the advertisement notifications are sent to subscriber patrons over the network for each of the plurality of venues which exceed a pre-defined ratings threshold.

Aspect 8

A system, comprising:
at least one sensor having network capability,
wherein the at least one sensor can measure at least one of fecal matter, allergens, viruses, or bacteria within a pre-defined airspace;
a sensor hub to collect and process measurement data from the at least one sensor;
an actuator coupled to the sensor hub; and
a gateway device communicatively coupled to the sensor hub to transmit the measurement data over a network to a cloud storage.

The system of Aspect 8, wherein the at least one sensor comprises a first senor that measures the fecal matter, a second sensor that measures the allergens, a third sensor that measures the viruses, and a fourth sensor that measures the bacteria.

The system of Aspect 8, wherein the actuator is a relay actuator.

The system of Aspect 8, wherein the at least one sensor reports the measurement data it obtained on a pre-defined frequency.

The system of Aspect 8, further comprises a subscriber patron smartphone device which receives alert notifications related to the measurement data based on user settings on the first subscriber patron smartphone device.

The system of Aspect 8, further comprises a subscriber patron smartphone device having a software application which creates a dashboard interface to display the measurement data.

The system of Aspect 8, further comprises a smart sticker which can provide updates regarding at least one of a cleaning schedule, protocols employed, or recent updates.

Aspect 9

A computing device comprising a non-transitory machine-readable storage medium containing instructions that, when executed, causes a machine to:
dispatch a plurality of advertisement notifications of a first venue to subscriber patrons; and
compute conversion metrics associated with the subscriber patrons which visited the venue after the plurality of advertisements are dispatched.

The computing device of Aspect 9, further comprises generating recommendations regarding sending out advertisement notifications based on the conversion metrics.

Aspect 10

A computing device comprising a non-transitory machine-readable storage medium containing instructions that, when executed, causes a machine to:
dispatch a plurality of advertisement notifications of a first venue to subscriber patrons according to a first pre-defined transmission schedule;
identify trends associated with subscriber patron visits after the plurality of advertisement notifications are dispatched; and
recommend an advertisement notifications transmission schedule based on the identified trends.

The computing device of Aspect 10, further comprises dispatching a plurality of discount notifications of the first venue to subscriber patrons according to the first pre-defined transmission schedule, identify trends associated with the subscriber patron visits after the plurality of discount notifications are dispatched, and recommend a discount notifications transmission schedule based on the identified trends.

The computing device of Aspect 10, further comprises dispatching a plurality of discount notifications of the first venue to subscriber patrons according to a second pre-defined transmission schedule, identify trends associated with the subscriber patron visits after the plurality of discount notifications are dispatched, and recommend a discount notifications transmission schedule based on the identified trends.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A computing device comprising a non-transitory machine-readable storage medium containing instructions that, when executed, causes a machine to:
receive a rating score of a venue's restroom cleanliness from subscriber patrons on a customer review platform over a network;
update an overall rating score of the venue's restroom cleanliness in response to receiving the rating score; and
dispatch services to the venue when a threshold number of ratings associated with the venue's restroom cleanliness is received within a first pre-defined time period.

2. The computing device comprising a non-transitory machine-readable storage medium of claim 1, further containing instructions, that when executed, causes the machine to receive reviews of the venue's restroom cleanliness from the subscriber patrons.

3. The computing device comprising a non-transitory machine-readable storage medium of claim 2, further containing instructions, that when executed, causes the machine to perform sentiment analysis of the review.

4. The computing device comprising a non-transitory machine-readable storage medium of claim 1, wherein the services are at least one of a janitorial service, a restroom attendant service, and a plumbing service.

5. The computing device comprising a non-transitory machine-readable storage medium of claim 1, further containing instructions, that when executed, causes the machine to send a reminder notification to the subscriber patron to submit a rating or review regarding the venue's restroom cleanliness.

6. The computing device comprising a non-transitory machine-readable storage medium of claim 1, further containing instructions, that when executed, causes the machine to reject the rating submission if the subscriber patron that submitted the rating was not within a pre-defined distance from the venue when the rating was submitted.

7. The computing device comprising a non-transitory machine-readable storage medium of claim 1, further containing instructions, that when executed, causes the machine to detect whether the subscriber patron has visited the venue and to reject the rating unless the subscriber patron submitted the rating within a second pre-defined time period from a time that the subscriber patron left the venue.

8. A computing device comprising a non-transitory machine-readable storage medium containing instructions that, when executed, causes a machine to:
retrieve a present location of a subscriber patron, the subscriber patron being a member of a network;
based on the present location of the subscriber patron, identify a plurality of venues within the network that are within a first pre-defined distance from the present location of the subscriber patron,
wherein each of the plurality of venues is associated with a restroom cleanliness rating calculated from the submissions of subscriber patrons over the network; and
present to the subscriber patron the identity of the plurality of venues within the first pre-defined distance according to the restroom cleanliness rating.

9. The computing device comprising a non-transitory machine-readable storage medium of claim 8, further containing instructions, that when executed, causes the machine to dispatch an advertisement notification to the subscriber patron when it is determined that the subscriber patron is within a second pre-defined distance from the at least one of the plurality of venues.

10. The computing device comprising a non-transitory machine-readable storage medium of claim 8, further containing instructions, that when executed, causes the machine to dispatch at least one of an advertisement notification, a discount notification, or a venue recommendation over the network based on the restroom-cleanliness review submissions by subscriber patrons over the network.

11. The computing device comprising a non-transitory machine-readable storage medium of claim 10, further containing instructions, that when executed, causes the machine to set the frequency and coverage area that the advertisement notifications are sent to subscriber patrons over the network.

12. The computing device comprising a non-transitory machine-readable storage medium of claim 10, further containing instructions, that when executed, causes the machine to issue an advertisement notification to the subscriber patron when it is determined that the subscriber patron is presently located in a venue where the subscriber patron previously submitted a review.

13. The computing device comprising a non-transitory machine-readable storage medium of claim 8, further containing instructions, that when executed, causes the machine to identify a second plurality of venues within the network that is within the pre-defined distance of the subscriber patron.

14. The computing device comprising a non-transitory machine-readable storage medium of claim 8, further containing instructions, that when executed, causes the machine to retrieve GPS data associated with the subscriber patron's client device to determine the present location of the subscriber patron.

15. The computing device comprising a non-transitory machine-readable storage medium of claim 8, further containing instructions, that when executed, causes the machine to log each occurrence that the subscriber patron which submitted the review of the venue's restroom cleanliness is detected within the pre-defined distance from the venue.

16. A server, comprising:
a first database of restroom cleanliness ratings data associated with a plurality of public venues, review data associated with the plurality of public venues, and location data associated with subscriber patrons and the public venues within a network; and
in response to receiving a first indication that a subscriber patron is seeking public venue options, the first database is configured to filter the restroom cleanliness rating and review data to identify each public venue that is within a pre-defined distance from the subscriber patron's location and which meets a first pre-defined rating and review threshold and dispatches public venue recommendations which meet the first pre-defined rating and review threshold.

17. The server of claim 16, further comprises a second database which includes ratings and reviews associated with a plurality of secondary cleaning services.

18. The server of claim 17, further comprises that when receiving a second indication that a subscriber proprietor has received a negative rating or review, the first database is configured to filter the first database to identify secondary cleaning services which have ratings and reviews that meet a second pre-defined rating and review threshold, and dispatch secondary cleaning service recommendations which meet the second pre-defined rating and review threshold to the subscriber proprietor.

19. The server of claim 16, further comprises a second database which includes location data of each subscriber patron.

20. The server of claim 19, wherein in response to receiving a first rating and review regarding a second public venue's restroom cleanliness, filter the second database of subscriber patron location data to identify the subscriber patrons that were located in the second public venue at the time that the first rating and review was dispatched, and dispatch a notification regarding the first rating and review to each of the subscriber patrons that were located in the second public venue at the time that the first rating and review was dispatched.
